(19) United States
(12) Patent Application Publication
(10) Pub. No.: US 2011/0024454 A1
(43) Pub. Date: Feb. 3, 2011

(54) DISPENSING CAP FOR BEVERAGE CONTAINER

(76) Inventors: Anita Dyrbye, St. Albert (CA); Mike Claerhout, Beaumont (CA)

Correspondence Address: DONALD V. TOMKINS;C/O TOMKINS LAW OFFICE, 740, 10150 - 100 STREET, EDMONTON, AB, T5J 0P6, CA

(21) Appl. No.: 12/937,516

(22) PCT Filed: Apr. 7, 2009
(86) PCT No.: PCT/CA2009/000452

§ 371 Date: Oct. 12, 2010

Related U.S. Application Data
(60) Provisional application No. 61/045,896, filed on Apr. 17, 2008.

(51) Int. Cl. B67D 7/74

(52) U.S. Cl. 222/129; 206/219

(57) ABSTRACT

A dispensing cap has an open-bottomed flow tube connected to a surrounding skirt by a resilient diaphragm, forming an storage chamber surrounding the flow tube. An annular base cap at the base of the flow tube is releasably engageable with the skirt to close off the bottom of the storage chamber. The dispensing cap is sealingly mountable to a beverage container with the skirt and storage chamber disposed within the throat of the container. A downward force applied to the flow tube will resiliently deform the diaphragm and downwardly disengage the base cap from the skirt, thus releasing the contents of the storage chamber into the container, which can then be agitated to mix the storage chamber contents with liquid in the container. The flow tube extends above the storage chamber and terminates in a flow assembly having a cap sleeve movable between a closed position and an “consume” position in which the contents of the container can flow through the flow tube and out an opening in the cap sleeve.

### FIELD OF THE INVENTION

The present invention relates in general to beverage container closure devices having reservoirs for holding an additive substance, and operative to dispense the additive substance into the container to facilitate mixing of the additive substance with the beverage.

### BACKGROUND OF THE INVENTION

It is known to use dispensing caps and closures with beverage containers such as bottled water and sport beverages. A dispensing cap incorporates a reservoir for receiving a quantity or dose of an additive substance, to be mixed with the base liquid (e.g., water; sport beverage) in the container. The additive substance could be of various types, and could be in either liquid or powdered form; examples would include flavoring ingredients, medicinal or pharmaceutical agents, dietary supplements, and therapeutic substances. Some additives may have diminished efficacy if mixed with the base liquid a significant length of time before consumption, or early mixing could reduce the mixture's shelf life. In other cases, such as for medicinal, therapeutic, or other health-related additives, proper proportioning of the additive may be important to ensure that the additive will have the desired benefits for the person consuming the mixture. Provision of the additive in a dispensing cap facilitates precise proportioning of the additive and base liquid, and also allows a consumer to ensure optimal freshness of the additive/base liquid mixture by dispensing the additive into the base liquid just prior to consumption.

The prior art discloses numerous examples of container closures for dispensing an additive into the container, including the following patent documents:
DE 31 40 398 A1
DE 42 38 819 A1
FR 1178 115 A1
FR 2 814 156 A1
JP 2002-282565
U.S. Pat. No. 4,315,570 A1
U.S. Pat. No. 5,217,433
U.S. Pat. No. 5,542,528
U.S. Pat. No. 5,839,573
U.S. Pat. No. 5,957,335
U.S. Pat. No. 6,435,341 B1
U.S. Pat. No. 6,513,650 B2
U.S. Pat. No. 6,540,070 B1
U.S. Pat. No. 6,854,595 B2
U.S. Pat. No. 6,959,839 B2
U.S. Pat. No. 7,503,453 B2
US 2007/0074979 A1
US 2007/0090000 A1
US 2008/0067172 A1
US 2008/0073307 A1
US 2008/0093381 A1
US 2008/0116221 A1
WO 2006/050538 A1
WO 2008/014444 A2

Notwithstanding the identified prior art, there remains a need for an improved dispensing cap for beverage containers, and the present invention is directed to that need.

### BRIEF SUMMARY OF THE INVENTION

In general terms, the present invention is a dispensing cap that may be screwed onto or otherwise sealingly mounted to a conventional beverage container, and which may be actuated to dispense an additive substance from a reservoir within the dispensing cap, into the beverage container. The dispensing cap has an open-bottomed flow tube which is connected to a surrounding skirt by means of a resilient diaphragm, forming an annular storage chamber surrounding the flow tube. A substantially rigid annular base cap is provided at the bottom of the flow tube, with the outer perimeter of the base cap being adapted for releasably sealing circumferential engagement with the skirt, so as to close off the bottom of the storage chamber. The dispensing cap is threaded or otherwise adapted for sealing attachment to a beverage container, such that the skirt and storage chamber are disposed within the throat or neck of the container. A downward force applied to the flow tube will induce resilient downward deformation of the diaphragm, disengagement of the base cap from the skirt, and downward displacement of the base cap relative to the skirt, thus opening the lower end of the storage chamber and releasing the contents thereof into the container, whereupon the container can be agitated to mix the storage chamber contents with a liquid in the container.

The flow tube extends above the storage chamber and terminates in a flow assembly which enables consumption of the container contents without removing the dispensing cap from the container. The upper end of the flow tube is closed off, and is sealingly engageable with an opening in a cap sleeve which is slidingly mounted over a wall structure defining a flow chamber. The portion of the flow tube disposed within the flow chamber has openings to permit liquid flowing in the flow tube to pass into the flow chamber. When the cap sleeve is in its closed position with the upper end of the flow tube engaging the cap sleeve opening, liquid cannot flow out of the container through the cap sleeve opening. When the cap is slidingly moved to its open position, with the upper end of the flow tube disengaged from the cap sleeve opening, liquid can flow from the container, through the flow tube, into the flow chamber, and out the cap sleeve opening.

### BRIEF DESCRIPTION OF THE DRAWINGS

Embodiments of the invention will now be described with reference to the accompanying figures, in which numerical references denote like parts, and in which:

FIG. 1 is an isometric section through a dispensing cap in accordance with one embodiment of the present invention, with the dispensing cap being screwed onto a beverage container and with security tab in place.

FIG. 2 is an elevational section through the dispensing cap of FIG. 1.

FIG. 3 is an isometric section through the dispensing cap of FIG. 1, with security tab removed in preparation for dispensing additive into the container.

FIG. 4 is an isometric section through the dispensing cap of FIG. 1, shown after actuation to dispensing additive from the reservoir.

FIG. 5 is an isometric section through the dispensing cp of FIG. 1, shown after actuation to allow consumption from the container.

### DETAILED DESCRIPTION OF THE PREFERRED EMBODIMENT

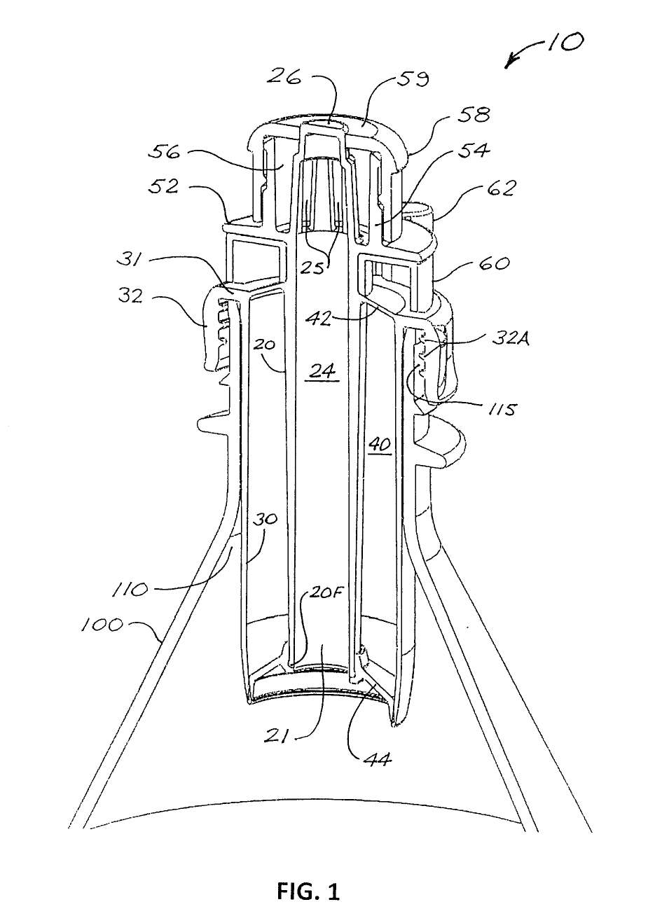

FIGS. 1-5 illustrate a preferred embodiment of the dispensing cap 10 of the present invention, shown mounted on a beverage container 100 having a throat section 110. In the illustrated embodiment, the dispensing cap 10 is adapted for mounting on a container 100 having a threaded neck, but this is not essential to the invention; the dispensing cap 10 of the present invention may be readily adapted for use with containers designed to receive alternative, non-threaded types of closures. All components of dispensing cap 10 are preferably made of a rigid or semi-rigid plastic material, but other materials providing suitable functional effectiveness may be used without departing from the scope of the present invention.

Dispensing cap 10 has a flow tube 20 having an upper end 20U and a lower end 20L. In the illustrated embodiment, flow tube 20 is of generally cylindrical configuration, and the descriptions herein will be in the context of a generally cylindrical flow tube 20. Persons of ordinary skill in the art will readily appreciate, however, that flow tube 20 could be of a different geometric configuration without departing from the scope of the present invention.

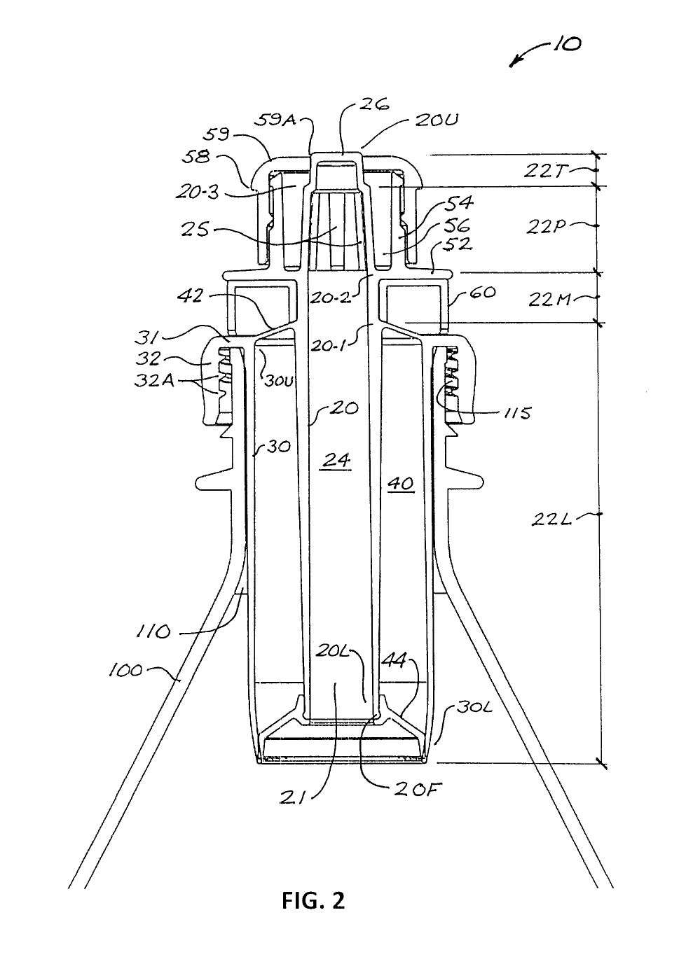

Having reference to FIG. 2, flow tube 20 may be considered as comprising four contiguous sections, as follows:
lower section 22L, extending upward from lower end 20L of flow tube 20 to a first intermediate point 20-1;
middle section 22M, extending upward from first intermediate point 20-1 to a second intermediate point 20-2 a selected distance above first intermediate point 20-1;
a perforated section 22P, extending upward from second intermediate point 20-2 to a third intermediate point 20-3 a selected distance above second intermediate point 20-2; and
a top section 22T, extending upward from third intermediate point 22-3 to upper end 20U of flow tube 20.

Lower end 20L of flow tube 20 has an opening 21 which leads into a flow passage 24 extending the full length of flow tube 20, from lower end 20L to upper end 20U. The cylindrical walls of flow tube 20 are solid except within perforated section 22P, which is formed with a plurality of perforations 25, for purposes to be explained herein. In the preferred and illustrated embodiment, perforations 25 are provided in the form of vertical slots, but this is not essential to the invention; perforations 25 could alternatively be provided in various other forms (e.g., round holes). In the preferred embodiment shown in the Figures, upper end 20U of flow tube 20 is closed off by a cap member 26. Top section 22T of flow tube 20 is preferably somewhat smaller in cross-sectional diameter than perforated section 22P. However, this feature is not essential to the invention, and in alternative embodiments top section 22T and perforated section 22P may be of substantially the same diameter.

Dispensing cap 10 also has a cylindrical skirt 30 which surrounds lower section 22L of flow tube 20, so as to form a generally annular storage chamber 40 between the inner surface of skirt 30 and the outer surface of lower section 22L of flow tube 20. The outer diameter of skirt 30 is smaller than the inner diameter of throat section 110 of the container 100 on which dispensing cap 10 is to be installed, such that skirt 30 may be readily disposed within throat section 110. Preferably (but not necessarily), the outer diameter of skirt 30 is only slightly smaller than the inner diameter of throat section 110, thus maximizing the volume of storage chamber 40. Skirt 30 has an upper end 30U and a lower end 30L. An annular skirt flange 31 extends radially outward from upper end 30U of skirt 30, and transitions at its outmost edge to a downwardly extending cylindrical collar 32. As may be seen in the Figures, collar 32 has internal threads 32A and is of a suitable diameter such that it can be screwed onto the top of container 100 with its internal threads 32A engaging the external threading 115 at the top of container 100.

A resiliently flexible and generally annular diaphragm 42 is circumferentially and sealingly connected to flow tube 20 at first intermediate point 20-1, and extends radially outward therefrom to circumferentially and sealingly connect to upper end 30U of skirt 30. Flow tube 20, skirt 30, and diaphragm 42 are preferably (but not necessarily) molded as an integral unit. Although this integral unit may thus be made of a rigid or semi-plastic material, the required flexibility of diaphragm 42 may be provided by making diaphragm 42 substantially thinner than the components to which it is connected (i.e., flow tube 20 and skirt 30).

A substantially rigid and generally annular base cap 44 is circumferentially and sealingly connected to flow tube 20 at lower end 20L, and extends generally radially outward therefrom for circumferentially sealingly engagement with lower end 30L of skirt 30. Unlike the connection of diaphragm 42 to upper end 30U of skirt 30, the circumferential engagement of base cap 44 with lower end 30L of skirt 30 is not integral, but is adapted to permit ready disengagement and downward displacement of base cap 44 relative to skirt 30 in response to application of a sufficient downward force on flow tube 20 relative to skirt 30.

As shown in the Figures, base cap 44 preferably (but not necessarily) has a downward slope radially away from lower end 20L of flow tube 20, to promote efficient and complete dispensing of an additive substance from.

Also as shown in the Figures, base flange 44 may be provided in the form of a discrete component that snaps onto a circumferential retention flange 20F formed at lower end 20L of flow tube 20. In alternative embodiments, however, base cap 44 could also be integrally formed or molded with flow tube 20.

Having reference to FIGS. 1, 2, and 3 and the foregoing descriptions, it will be seen that when base cap 44 is sealingly engaged with lower end 30L of skirt 30, annular storage chamber 40 becomes a sealed and preferably liquid-tight chamber. Storage chamber 40 may be filled or partially filled with a selected additive substance in liquid, powder, or other form as appropriate.

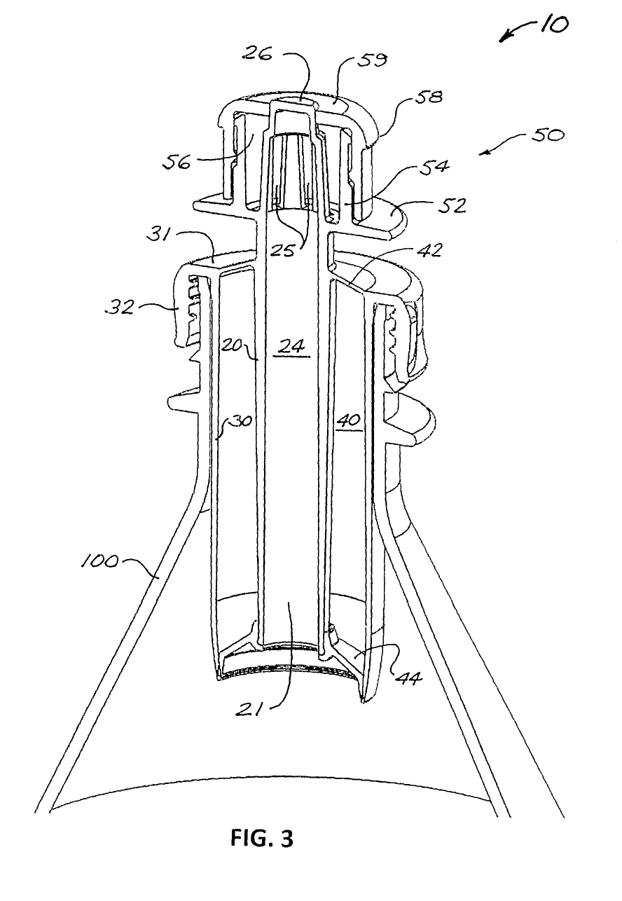

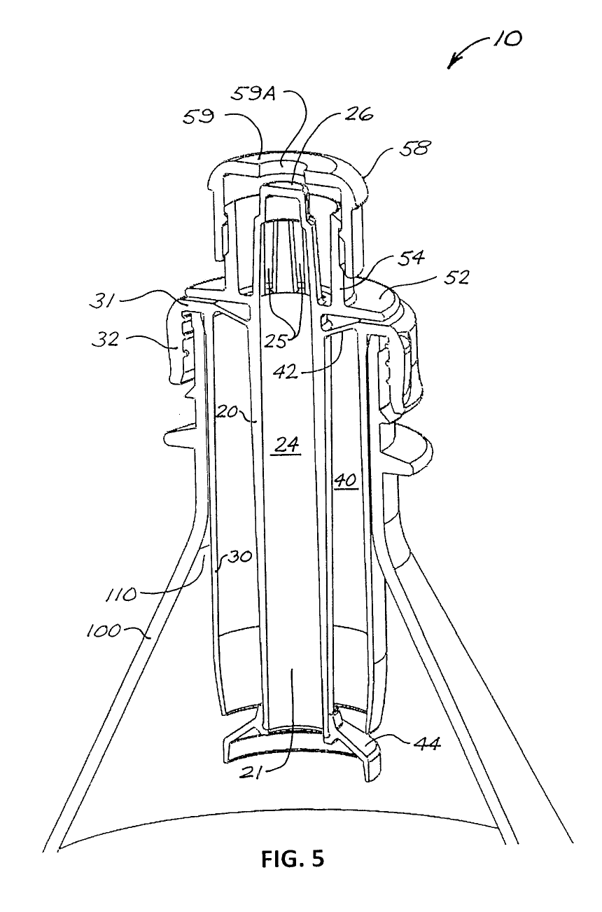

Dispensing cap 10 also incorporates a beverage flow assembly 50, which may be most clearly understood with reference to FIG. 3. In the illustrated embodiment, flow assembly 50 comprises a base flange 52 which extends radially outward from second intermediate point 20-2 on flow tube 20. An open-topped cylindrical flow chamber wall 54 extends upward from base flange 52, forming a generally annular flow chamber 56 surrounding perforated section 22P of flow tube 20. A generally dome-shaped, cylindrical cap sleeve 58 having a top closure member 59, with a flow opening 59A formed in top closure 59, is disposed over and around flow chamber wall 54 such that cap sleeve 58 is slidingly movable relative to cylindrical wall 54 between:
a closed position (as seen in FIGS. 1 to 4) in which top section 22T of flow tube 20 sealingly engages flow opening 59A; and
an open position (as seen in FIG. 5) in which top closure 59 is displaced to a position above top section 22T of flow tube 20 such that liquid can flow our of flow chamber 56 through flow opening 59A.

Flow chamber wall 54 and cap sleeve 58 are designed and configured such that cap sleeve 58 forms a substantially liquid-tight seal against flow chamber wall 54 as cap sleeve 58 moves between the closed and open positions. The Figures conceptually illustrate one particular design whereby this liquid-tight seal may be achieved, but the present invention is not limited to this or any other particular method or means of providing a sliding seal between cap sleeve 58 and flow chamber wall 54, which as persons skilled in the art will recognize can be accomplished in a variety of ways using known technology.

Although flow chamber wall 54 is described and illustrated herein as being generally cylindrical, persons skilled in the art will readily appreciate that flow chamber wall 54 and flow chamber 56 could be of different geometric configurations (with corresponding modifications to cap sleeve 58) without departing from the scope of the present invention.

As shown in FIGS. 1 and 2, a generally annular security tab 60, with pull tab 62, is preferably (but not necessarily) disposed provided around middle section 22M of flow tube 20, between skirt flange 31 and base flange 52. As will be explained in greater detail below, security tab 60 prevents unintentional release of the additive substance from storage chamber 40, as could result from inadvertent downward displacement of flow tube 20 relative to skirt 30. Accordingly, security tab 60 will typically be left in place until it is desired to release the additive substance into container 100.

The particular security tab configuration shown in the Figures is exemplary only. Embodiments of the present invention incorporating a security tab are not limited or restricted to the use of a security device as specifically illustrated herein or in accordance with any other particular design or style.

The operation of dispensing cap 10 may be readily understood with reference to the Figures and the foregoing descriptions. FIGS. 1 and 2 illustrate dispensing cap 10 threadingly mounted over the threaded neck of a beverage container 100, with skirt 30 (and lower section 22L of flow tube 20) disposed within throat 110 of container 100. Security tab 60 is in place, storage chamber 40 has been filled with a selected additive substance (not shown), and cap sleeve 58 is in the closed position.

FIG. 3 illustrates dispensing cap 10 essentially as in FIGS. 1 and 2 but with security tab 60 removed.

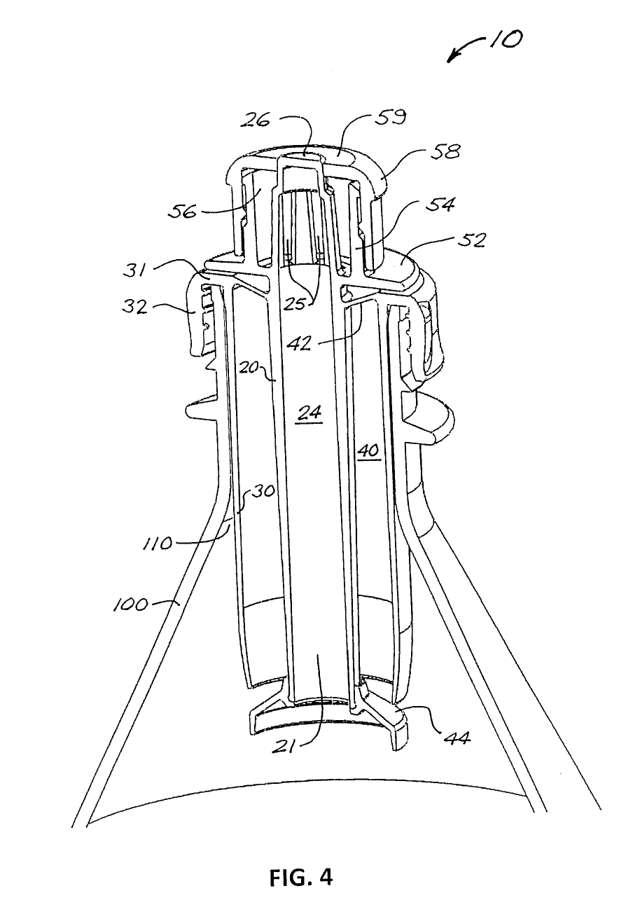

FIG. 4 illustrates dispensing cap 10 in the “dispense” position, which is achieved by applying a downward force on top closure 59 (and flow assembly 50 as a whole), such that flow tube 20 moves downward within skirt 30 (with corresponding deformation and downward deflection of diaphragm 42), causing base cap 44 to become disengaged from and displaced below lower end 30L of skirt 30, such that the additive substance will readily flow out of storage chamber 40 and into container 100, whereupon the additive substance will become mixed with the liquid (e.g., water; sport beverage) in container 100.

FIG. 5 illustrates dispensing cap 10 in the open or “consume” position, which is achieved subsequent to the release of the additive substance from storage chamber 40, by simply sliding cap sleeve 58 into the “consume” position as previously described. With dispensing cap 10 in the “consume” position, container 100 may be tilted or inverted to allow the mixed beverage to flow through opening 21 of flow tube 20 into flow passage 24 within flow tube 20, and thence through perforations 25 in perforated section 22P of flow tube 20 into flow chamber 56, and out through flow opening 59A in top closure 59.

A particular advantage of the present invention is that it provides the beverage consumer with the option of drinking the base liquid from container 100 without releasing the additive substance from storage chamber 40 into container 100. This may be done by simply by sliding cap sleeve 58 into the “open” position without displacing flow tube 20; this can be done with security tab 60 either removed or in place.

Another advantage of the present invention is that it gives the beverage consumer the option of releasing only a portion of the additive substance into container 100. This can be done by, for example, displacing flow tube 20 only partially downward and then retracting flow tube 20 (by pulling upward on base flange 52) so as to sealingly re-engage base cap 44 with lower end 30L of skirt 30, thus retaining the remaining amount of additive substance within storage chamber 40 until the consumer is ready to dispense it into container 100 at a later time.

It will be readily appreciated by those skilled in the art that various modifications of the present invention may be devised without departing from the essential concept of the invention, and all such modifications are intended to come within the scope of the present invention and the claims appended hereto. It is to be especially understood that the invention is not intended to be limited to illustrated embodiments, and that the substitution of a variant of a claimed element or feature, without any substantial resultant change in the working of the invention, will not constitute a departure from the scope of the invention.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element. The word “sealing” and derivative forms thereof, as used herein, are to be understood as connoting the provision of a substantially liquid-tight seal. As used in this patent document, the words “cylindrical”, “annular”, or other words relating to shape, form, or properties are not intended to denote or require geometrical or technical precision, and are accordingly to be understood as denoting general or substantial conformity (e.g., “cylindrical” would be understood as “at least substantially cylindrical”) unless the context clearly requires otherwise.

The embodiments of the invention in which an exclusive property or privilege is claimed are defined as follows:

1. A dispensing cap sealingly mountable to a beverage container, said dispensing cap comprising:
(a) an open-bottomed flow tube;
(b) a skirt surrounding the flow tube so as to form an annular chamber between the flow tube and the skirt, said skirt being adapted for disposition within the throat of the beverage container;
(c) a resilient annular diaphragm sealingly connecting an upper perimeter region of the skirt and an intermediate perimeter region of the flow tube; and
(d) an annular base cap sealingly connected to a lower perimeter region of the flow tube, and sealingly and releasably engageable with a lower perimeter region of the skirt;
characterized in that when the dispensing cap is mounted to the beverage container with the skirt disposed within the throat thereof and with a quantity of additive substance stored in the storage chamber, a downward force applied to the flow tube will resiliently deform the diaphragm and disengage the base cap from the skirt, thus allowing the contents of the storage chamber to flow into the container.

2. The dispensing cap of claim 1, further comprising a flow assembly having a cap sleeve operable between an open position in which liquid can flow from the container into the flow tube and out of a flow opening in the cap sleeve, and a closed position in which liquid flow from the container through the flow assembly is prevented.

3. The dispensing cap of claim 2 wherein the upper end of the flow tube is closed and an upper region of the wall of the flow tube has one or more perforations, and wherein the flow assembly comprises:
(a) a base flange sealingly connected, along its inner circumference, to the outer perimeter of the flow tube at a point below said perforations;
(b) an open-topped perimeter retaining wall having a lower end sealingly connected to the base flange so as define an annular chamber between the perimeter wall and the flow tube; and
(c) a cap sleeve comprising a top closure and an open-bottomed perimeter sidewall extending downward from the top closure, wherein:
c.1 the top closure has a flow opening adapted for releasably sealing engagement with the upper end of the flow tube; and
c.2 the perimeter sidewall is sealingly slidable over said retaining wall, between a closed position in which the upper end of the flow tube is sealingly engaged within said flow opening in the top closure, and an open position in which liquid can flow through the flow opening;

4. A dispensing cap as in claim 1, 2 or 3, further comprising a security tab disposable around the flow tube in a region between the base flange and the diaphragm.

5. A dispensing cap for a beverage container, said dispensing cap comprising:
(a) a flow tube having a sidewall, a closed upper end, and an open lower end, with an upper region of said sidewall having one or more perforations;
(b) an annular base flange sealingly connected, along its inner circumference, to the outer perimeter of the flow tube at a point below said perforations;
(c) an open-topped perimeter retaining wall having a lower end sealingly connected to the base flange so as define an annular chamber between the perimeter wall and the flow tube;
(d) a cap member having a top closure and an open-bottomed perimeter sidewall extending downward from the top closure, wherein:
d.1 the top closure has a flow opening adapted for releasably sealing engagement with the upper end of the flow tube; and
d.2 the perimeter sidewall is sealingly slidable over said retaining wall, between a closed position in which the upper end of the flow tube is sealingly engaged within said flow opening in the top closure, and an open position in which liquid can flow through the flow opening;
(e) a cylindrical skirt surrounding a lower region of the flow tube and defining an annular space therebetween, said skirt having upper and lower ends;
(f) an annular diaphragm, sealingly connected:
f.1 along its inner circumference, to the outer perimeter of the flow tube at a point below the base flange; and
f.2 along its outer circumference, to the upper end of said skirt;
(g) an annular base cap:
g.1 sealingly connected, along its inner circumference, to the lower end of the flow tube; and
g.2 sealingly and releasably engageable, along its outer circumference, with the lower end of the skirt; and
(h) an annular collar extending outward from the upper end of the skirt, and adapted for sealing connection to a beverage container when the cylindrical skirt is disposed within the throat of the container.

6. A dispensing cap as in claim 5, further comprising a security tab disposable around the flow tube in a region between the base flange and the diaphragm.
